(19) United States
(12) Patent Application Publication
(10) Pub. No.: US 2008/0312015 A1
(43) Pub. Date: Dec. 18, 2008

(54) Torsional vibration damper or decoupler with wound wire springs in a drive pulley

(76) Inventors: Michael Schebitz, Attendorn (DE); Matthias Zacker, Attendorn (DE)

Correspondence Address: WYATT, GERBER & O'ROURKE, 99 PARK AVENUE, NEW YORK, NY, 10016, US

(21) Appl. No.: 12/156,750

(22) Filed: Jun. 4, 2008

(30) Foreign Application Priority Data
Jun. 4, 2007 (DE) 102007026195.2-27

(51) Int. Cl. F16H 55/36

(52) U.S. Cl. 474/94

(57) ABSTRACT

A drive pulley having a hub and a pulley rim is provided, which are mounted in one another so as to be rotatable about a rotational axis, with at least two wound wire springs which are arranged in each case between the hub and the pulley rim in such a manner that they are wound around the rotational axis. In each case one end is supported in the direction of rotation with respect to the hub and the other end is supported in the direction of rotation with respect to the pulley rim and which form a non-supported free spring length between the ends, and which are installed in such a manner that they are pretensioned with respect to each other. At least one of the wire springs bears at one end against a bearing region of one of the parts—hub and pulley rim—and then has a radial distance with respect to a curved supporting face on this one of the parts—hub and pulley rim respectively—which distance increases over the circumference and is reduced progressively to zero over the circumference when the parts—hub and pulley rim—are twisted with respect to each other, while the bearing region is extended into the region of the supporting face 45 and the free spring length is shortened.

### BACKGROUND OF THE INVENTION

The invention relates to a drive pulley, on which a hub and a pulley rim are connected to each other by means of a spring and damping element—such as a torsional vibration damper or decoupler—for the purpose of transmitting torque. The drive can be provided from the pulley rim to the hub or from the hub to the pulley rim. The hub can be screwed to a drive shaft. The drive shaft can be provided as a crankshaft or a camshaft for an internal combustion engine, and auxiliary drives can be provided and driven by means of the drive pulley. Owing to the periodic operation of internal combustion engines, or for example, of piston compressors, non-uniformities in the angular velocity and torque can occur at the shaft ends of these machines. These non-uniformities can be intensified by vibration and resonance of the shafts. In order to dampen these non-uniformities in the drive to the auxiliary drives, drive pulleys have been proposed with a hub and a pulley rim which are mounted in one another so as to be rotatable, with at least two wire springs which are wound in opposite directions and are installed in such a manner that they are wound around the rotational axis between the hub and the pulley rim and pretensioned with respect to each other. In each case one end is fixed in the direction of rotation with respect to the hub and the other end is fixed in the direction of rotation with respect to the wheel pulley (EP 1 760 355 A1).

In this case the wire springs have a linear characteristic by remaining freely deformable between their connection regions on the hub and at the pulley rim in the entire working region of the drive pulley.

The working region of the drive pulley herein is the range of relative rotation of the hub and pulley rim against the restoring forces of the wire springs for the purpose of impact and vibration damping.

In order to delimit the working region, rotation stops can be provided between the hub and the pulley rim.

In the course of efforts to reduce CO₂ emissions, vehicles are increasingly being introduced with a start/stop function and/or an energy retrieval function. For this purpose, internal combustion engines are provided with starter generators, in which an electrical machine is coupled to the crankshaft of the internal combustion engine by means of a belt drive, and which can work as an electric generator as well as a starting motor. When starting, the torque to be delivered from the electrical machine to the internal combustion engine is much higher than the torque transferred from the internal combustion engine to the electrical machine during engine drive.

During the starting process, the drive torques can be absorbed with drive pulleys of the known type in the belt drive only by using the rotation stops between the hub and the pulley rim. This can result in undesirable loading peaks due to impacts at the rotation stops which are very disadvantageous mechanically and acoustically.

### SUMMARY OF THE INVENTION

Accordingly, an object of the present invention is to provide a drive pulley, which can transmit the greatly increased output torques of a starter generator in the starter mode in an improved manner, while providing a device having a compact construction, which operates quietly and which has uniformly beneficial and freely selectable spring and damping properties.

A drive pulley according to the invention comprises a hub and a pulley rim, which are mounted in one another so as to be rotatable, with at least two wire springs which are wound around the rotational axis between the hub and the pulley rim and which are installed in such a manner that they are pretensioned with respect to each other. In each of the springs, one end region is fixed in the direction of rotation with respect to the hub and the other end region is fixed in the direction of rotation with respect to the pulley rim and which form a non-supported free spring length between the end regions. At least one of the wire springs of the drive pulley bears at one end region against a bearing region of one of the parts—hub and pulley rim. In addition, at least one of the wires of the drive pulley has a radial distance with respect to a curved supporting face on this one of said parts—hub and pulley rim—which distance increases over the circumference and is reduced progressively to zero over the circumference when the parts—hub and pulley rim—are twisted with respect to each other, while the bearing region is extended into the region of the supporting face and the free effective spring length is shortened. When loaded, at least one wire springs unrolls against a curved supporting face, and the effective free spring length between the supported end regions can become shortened. In addition, the stiffness of the wire spring can increase progressively as the deflection of the parts of the drive pulley—hub and pulley rim—increases. If the at least one wire spring has borne against the curved supporting face to a maximum extent, the parts of the drive pulley may not be deflected any further, that is, the hub and pulley rim may not be twisted any further with respect to each other, and accordingly the drive pulley can be considered to be a rigid pulley with regard to the deflection of the parts.

Very high drive torques can be transmitted without load peaks occurring. This can create the necessary prerequisites for starter generator operation since in the starter mode, the internal combustion engine with its entire inertia may need to be dragged against the engine compression and the internal friction. The pulley according to the invention can be arranged on the crankshaft of the internal combustion engine and/or on the shaft of the electrical machine. Herein at least one wire spring can be installed in accordance with the invention and is additionally loaded in the starter mode.

The above-mentioned curved supporting face can preferably be an inner cylinder face of the pulley rim, on which one of the at least one of the wire springs progressively bears in a widening movement. In an alternative embodiment, the curved supporting face can also be an outer cylinder face of the hub on which the corresponding wire spring increasingly winds up as the curve profile tightens.

In accordance with both the above mentioned embodiments, the radial distance of the at least one of the wire springs from the supporting face on the unloaded drive pulley can increase continuously in the circumferential direction starting from the bearing region. The progression of the spring characteristic can be substantially even.

In another embodiment of a pulley according to the invention, the curve supporting face can be an inner cylinder section face in the pulley rim with an adjoining narrowing spiral face against which at least one of the wire springs can set progressively in a widening movement. In addition or in the alternative, the curved supporting face can be an outer cylinder section face on the hub with an adjoining widening spiral face on which the at least one of the wire springs can be progressively wound up in a narrowing movement.

In accordance with both the last mentioned embodiments, the radial distance of the at least one of the wire springs from the supporting face on the unloaded drive pulley can increase first and then can be constant and/or decreases in the circumferential direction starting from the bearing region. Accordingly, an increasing progression of the spring characteristic can be provided with an increasing load, i.e., an increasing stiffening of the at least one of the wire springs.

The function of the wire springs progressively setting against the curved supporting face can in each case affect the spring characteristic of the drive pulley while the wire springs which are in each case wound in the opposite directions and are partially relieved of load starting from their pretensioned installation position. With regard to the particular load case of starting, the wire springs which are wound in opposite directions can have characteristic curves which differ from each other. When wire springs of the same type are used, however, a reduction of the variety of parts can advantageously be achieved.

A concrete spring design can be found in spiral springs which are wound in one plane and in each case comprise two end regions for fixing the springs. The springs can have constant curvature radii which can differ from each other and can be provided with a connected region which opens spirally.

It can be appreciated that the function stated here can also be realised by means of helically wound springs with a larger axial extent, in which case the spring design can be slightly conical.

The curved supporting face is preferably in each case a pure cylinder face, provided internally in the pulley rim or provided externally on the hub. Non-concentric supporting faces with a specific curve profile can be configured on the pulley rim or on the hub, ensuring that the radial distance variably changes over the circumference. With regard to possible imbalances, equilibrations can be created in this case.

The use of at least two wire springs within the drive pulley which are wound around the rotational axis can produce a very compact construction which can decouple the effect of the spring and the damping since the springs only have relatively low internal damping and frictional faces can be provided on the hub and the pulley rim for setting the damping. Wire springs can ensure a long service life which may be largely unaffected by the ambient temperature and other environmental influences. The number of components is low and enables a simple axial assembly. Use of the metallic materials reduces problems related to the conduction of heat.

As already mentioned, at least two wire springs are provided which are wound in opposite directions, or installed in opposite senses, and which are installed in such a manner that they are pretensioned with respect to each other. In this case the springs can be supported with their ends or end regions on the hub or on the pulley rim in such a manner that a form fit can be produced in only one direction of rotation. Even given a maximum relative twisting of hub and pulley rim with respect to each other, a pretension in both wire springs can be provided so that the form-fitting bearing of both wire springs on the parts—hub and pulley rim—can be maintained constantly.

Instead of the two said wire springs, two groups of wire springs can also be used and installed in the manner described with pretensioning with respect to one another. The ends of the springs can be cut off so as to be blunt and can be supported against corresponding rotation stops on the hub and/or in the pulley rim.

In a preferred embodiment, the at least two wire springs are in each case wound spirally in one plane; this results in a very short construction. The wire springs can in each case have more than one complete spiral coil.

In order to set the damping properties, intermediate pulleys or supporting pulleys can be provided to lie between the wire springs and/or by means of which the wire springs can be supported axially in the interior of the hub.

A belt pulley for a V belt, a poly V belt, a toothed belt or a chain wheel can be configured on the pulley rim, either directly or as a fitted-on part.

Sliding or friction pulleys can be inserted between the hub and the pulley rim. Furthermore, a sliding or friction bushing can be used between the circumferential face of the hub and the pulley rim. These parts, which can be comprised of plastic, can be used for setting freedom of play and can be used to vary the damping effect.

In another embodiment, the hub can be comprised of a bowl-shaped part and an annular bowl-shaped part, with the annular bowl-shaped part being placed on the bowl-shaped part in such a manner that the hub forms an annular groove in which the wire springs can sit. In addition, the pulley rim can comprise a guide pulley which can be engaged in the annular groove of the hub and can include a belt rim which can form two annular spaces with the annular groove, which spaces are separated from the guide pulley and in which the two wire springs can sit. In this case, each of the wire springs can be directly supported against rotation stops on the hub on one side and against the pulley rim on the other side respectively without having to penetrate one of the two parts. Instead of a pure form fit, a force fit by means of clamping or welding can also be used. The two parts of the hub are in this case installed after the wire springs and the pulley rim have been fitted onto the bowl section of the bowl-shaped part. The bowl-shaped part as well as the annular bowl-shaped part can be fabricated as multiply stepped deep-drawn parts comprising sheet metal, which can be configured without undercuts in each case as viewed in one direction.

At least one sliding or friction bushing can be provided between the hub and the pulley rim in order to set the damping properties, with it being possible in particular for the sliding or friction bushing to surround the guide pulley laterally and/or internally.

The at least two wire springs are preferably wound using round wire; but oval wire or square wire can be used in order to improve bearing. The hub can be screwed to a shaft journal or a shaft, and the screw-fastening means can be used for connecting the two parts of the hub for the sake of simplicity. To this end, the hub can be configured with a simple inner flange which can be formed from both parts.

In order to ensure a connection to the adjoining shaft journal, which can be highly loaded with torque given a small screw-on face of an inner flange of the hub, the corresponding flange face on the hub can be provided with face toothing, in particular with Hirth toothing, which can interact with a corresponding counter-toothing on the end face of the shaft journal to be adjoined. A central screw can be sufficient for the mutual bracing, which screw can be placed through the inner flange and screwed centrally into the end of the shaft journal.

In order to further favourably influence the vibration behaviour of the shaft, in particular in order to absorb high-frequency vibrations, an annular absorber mass can be connected to the hub by means of a damper rubber in such a manner that it can vibrate.

Preferred exemplary embodiments of the invention are shown in the drawings and are described below.

### BRIEF DESCRIPTION OF THE DRAWINGS

FIG. 1 shows the assembly of a first embodiment of a drive pulley according to the invention

a) in an axial view

b) in a radial side view

c) in a longitudinal section A-A according to illustration a);

FIG. 2 shows the pulley rim of the drive pulley according to FIG. 1 as a detail with wire springs

a) in an axial view

b) in a radial end face view

c) in a longitudinal section C-C according to illustration a);

d) in a longitudinal section B-B according to illustration a);

FIG. 3 shows the assembly of a second embodiment of a drive pulley according to the invention

a) in an axial view

b) in a longitudinal section A-A according to illustration a)

c) in a longitudinal section B-B according to illustration a)

d) in a radial side view

e) in a cross section C-C according to illustration d);

FIG. 4 shows the pulley rim of the drive pulley according to FIG. 3 as a detail with wire springs

a) in an axial view

b) in a longitudinal section A-A according to illustration a)

c) in a longitudinal section B-B according to illustration a)

d) in a radial side view

e) in a cross section C-C according to illustration d).

FIG. 5 shows the spring characteristic of a wire spring installed according to the invention against the angle of rotation

FIG. 6 shows the characteristic of a drive pulley according to the invention and the spring characteristic in each case against the angle of rotation

### DETAILED DESCRIPTION

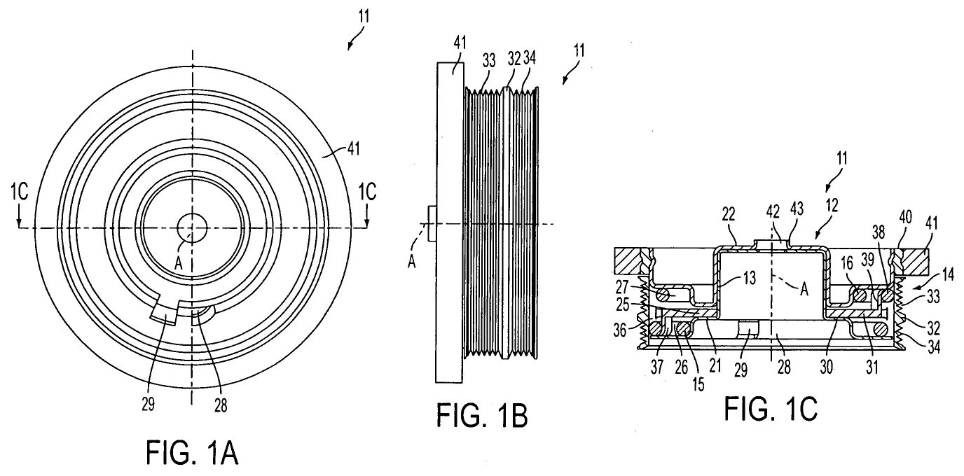

FIG. 1 shows a drive pulley 11 according to the invention in an axial view (a), in a radial view (b) and in a longitudinal section (c). The drive pulley 11 comprises a hub 12 which can be screwed on a shaft journal by means of screw-fastening means. It furthermore comprises a pulley rim 14, which is connected in a rotationally elastic manner to the hub 12 by means of two spirally wound wire springs 15, 16. The wire springs 15, 16 are in each case wound spirally in more than one coil and can be supported in each case with a cut off end in the direction of rotation in a form-fitting manner against the pulley rim 14 and with the other cut off end supported in a form-fitting manner against the hub 12. The hub 12 includes a first part 21 which is bowl-shaped, viewed from the first outer side, and a second part 22 which is annular bowl-shaped, viewed from the second outer side, with the parts being connected to each other axially and in a rotationally fixed manner by means of axial pressing to form a press fit 13. The bowl-shaped part 21 is in this case pushed in the inner region into the annular bowl-shaped part 22. The hub 12 in this case forms an annular groove 25 which is stepped across its width and has flanks which are parallel to each other. The bowl-shaped part 21 is a sheet metal part of approximately constant wall thickness, which is multiply stepped and forms two cylinder sections. The part 21 is axially free of undercuts. It can be configured in particular as a deep-drawn part. The second, annular bowl-shaped part 22 is likewise configured as a sheet metal part of approximately constant wall thickness, which is multiply stepped and forms three cylinder sections. The second annular bowl-shaped part 22 is likewise axially free of undercuts and can likewise be fabricated as a deep-drawn part. The part 22 sits with the cylinder section of the smallest diameter on the smallest cylinder section of the first annular bowl-shaped part 21 and forms with the latter the annular groove 25 which comprises a relatively narrow and deep part and a relatively wide and shallow part. A bushing 43 is formed centrally on the annular bowl-shaped part 22. A penetration opening 42 can receive a central screw.

Before the parts 21 and 22 are joined, the wire springs 15, 16 and the pulley rim 14 in between, which is configured as one piece, are to be inserted axially between the two wire springs. The pulley rim 14 comprises an approximately centrally configured radial guide pulley 31 and a belt pulley 32 which forms the belt seat 33, 34 for two poly V belts. The guide pulley 31 is guided in the relatively deep, narrow part of the annular groove 25 of the hub 12 by means of a sliding or friction bushing 30 with a U-shaped cross section. At the same time the guide pulley 31 forms with the hub 12 two annular spaces 26, 27 for the two wire springs 15, 16. Whereas an inner rotation stop 38 and a guide loop 39 for the wire spring 15 can be seen on the first bowl-shaped part 21 of the hub 12, which are in each case formed out of the sheet metal, a corresponding inner rotation stop and a corresponding guide loop for the wire spring 16 are likewise provided on the other annular bowl-shaped part 22 of the hub 12 but cannot be seen here. These parts are in each case stamped out of the sheet metal.

After assembly, both wire springs 15, 16 should in each case be pretensioned with respect to each other, that is, should be spread radially compared to their untensioned starting position. With each relative twisting between the hub 12 and the pulley rim 14, one of the springs is additionally tensioned, whereas the second spring is detensioned without being entirely relieved of load, that is, the bearing against the respective rotation stop under pretensioning force should be maintained. The damping takes place on the one hand by means of the internal material damping of the wire springs 15, 16 and on the other hand by means of the relative surface friction between the guide pulley 31 of the pulley rim 14 and the annular groove 25 in the hub 12, which friction can be set by means of the properties and the lining of the sliding or friction bushing 30.

Furthermore, an annular absorber mass 41 is arranged on the largest cylinder section of the annular bowl-shaped part 22, which absorber mass is configured so as to be able to vibrate rotationally with respect to the hub 12 by means of a vulcanized-on damper rubber 40 in order to absorb high-frequency vibrations. Vibrations of a shaft journal from the pulley rim 14 are to be effectively insulated thereby.

The rotational axis of the drive pulley is designated A. The rotational axis can include both the axis of rotation of the drive pulley as a whole as well as the axis of relative rotation between the hub 12 and the pulley rim 14.

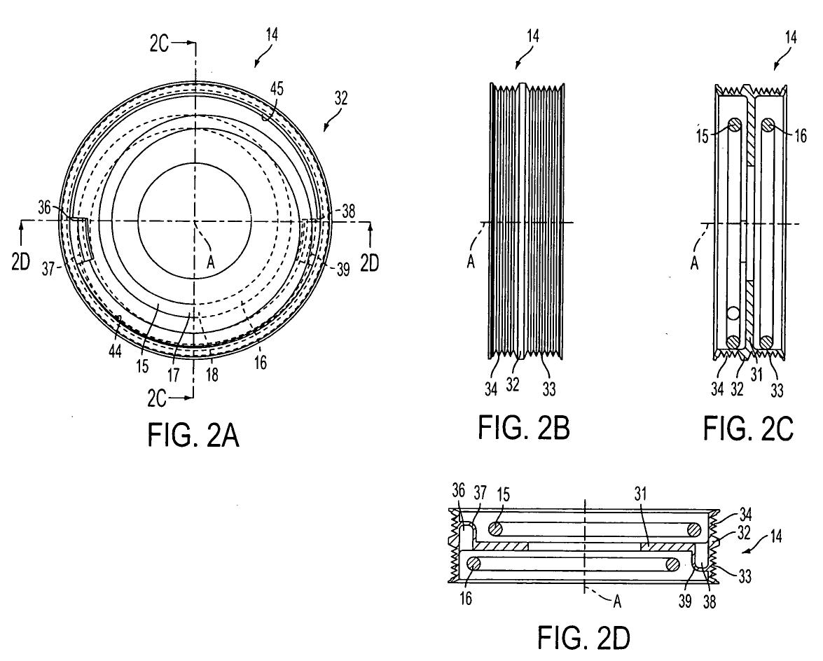

FIG. 2 shows the drive pulley 14 according to FIG. 1 as an assembly with the wire springs 15, 16, with the same details being referred to with the same reference symbols. The wire spring 15, the pulley rim 14 and the wire spring 16 can be seen in detail. An outer rotation stop 36 and a guide loop 37 for the wire spring 15, as well as an outer rotation stop 38 and a guide loop 39 for the wire spring 16 are shown on the pulley rim 14. The pulley rim 14 is a moulded sheet metal part, with the belt pulley 32 on the pulley rim 14 being fabricated from a radially split outer edge of a blank. Two end regions with uniform curvature of different radii and a connecting spiral region can be seen on the wire spring 15 which is situated at the front. The end region with the larger radius bears against the cylindrical bearing region 44 of the belt rim 32, whereas the spiral region with the cylindrical supporting region 45 of the belt rim 32 encloses a distance which increases over the circumference. This distance is reduced progressively to zero when the hub and thus the inner end 17 of the spring is twisted with respect to the pulley rim 14 to the right as a result of an anti-clockwise widening of the spring 15. In this case the non-bearing deformable free spring length is shortened and the characteristic of the drive pulley becomes increasingly stiff. For the oppositely wound, dashed wire spring 16 behind, the same applies correspondingly for a twisting of the hub and thus the inner end 18 of the spring against the pulley rim 14 to the left, which then leads to the wire spring 16 widening.

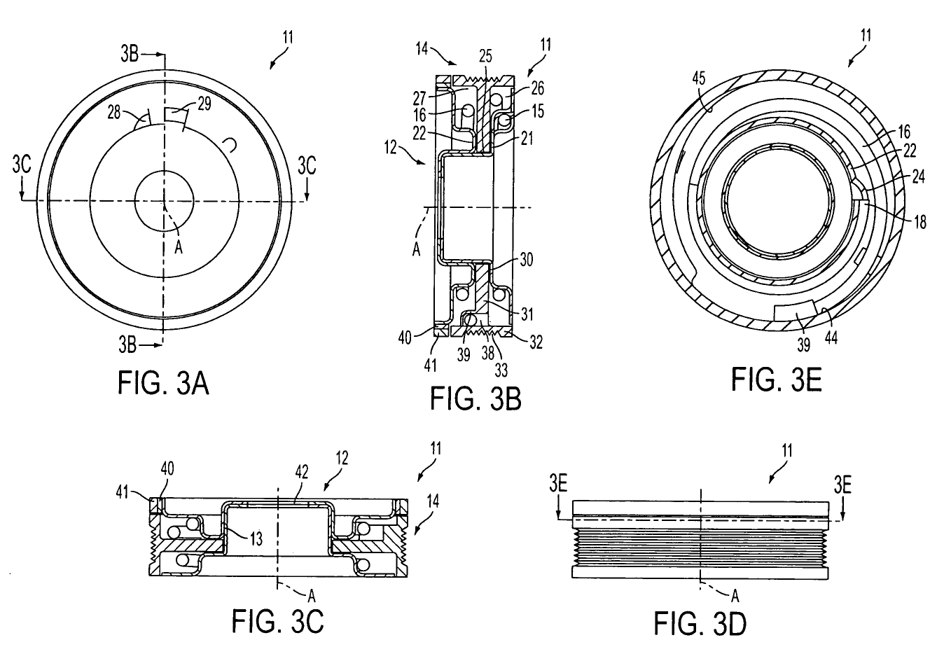

FIG. 3 shows a further embodiment of a drive pulley 11 according to the invention, in an axial view (a), in a first longitudinal section (b) according to section line A-A from view (a), in a second longitudinal section (c) according to section line B-B from view (a), in a radial view (d) and in cross section according to section line C-C from view (d). The drive pulley 11 comprises a hub 12 which can be screwed on a shaft journal by means of screw-fastening means. It furthermore comprises a pulley rim 14, which is connected in a rotationally elastic manner to the hub 12 by means of two spirally wound wire springs 15, 16. The wire springs 15, 16 are in each case wound spirally in more than one coil and can be supported in each case with a cut off end in the direction of rotation in a form-fitting manner against the pulley rim 14 and with the other cut-off end in a form-fitting manner against the hub. The hub 12 includes a first part 21 which is bowl-shaped, viewed from the first outer side, and a second part 22 which is annular bowl-shaped, viewed from the second outer side, with the parts being connected to each other axially and in a rotationally fixed manner by means of axial pressing to form a press fit 13. The bowl-shaped part 21 is in this case pushed in the inner region into the annular bowl-shaped part 22. The hub 12 in this case forms an annular groove 25 which is stepped across its width and has flanks which are parallel to each other. The bowl-shaped part 21 is a sheet metal part of approximately constant wall thickness, which is multiply stepped and forms two cylinder sections. The part 21 is axially free of undercuts. It can be configured in particular as a deep-drawn part. The second, annular bowl-shaped part 22 is likewise configured as a sheet metal part of approximately constant wall thickness, which is multiply stepped and forms three cylinder sections. The second annular bowl-shaped part 22 is likewise axially free of undercuts and can likewise be fabricated as a deep-drawn part. The part 22 sits with the cylinder section of the smallest diameter on the smallest cylinder section of the first annular bowl-shaped part 21 and forms with the latter the annular groove 25 which comprises a relatively narrow and deep part and a relatively wide and shallow part. A penetration opening 42 can receive a central screw.

Before the parts 21 and 22 are joined, the wire springs 15, 16 and the pulley rim 14 in between, which is configured as one piece, are to be inserted axially between the two wire springs. The pulley rim 14 comprises an approximately centrally configured radial guide pulley 31 and a belt pulley 32 which forms the belt seat 33 for a poly V belt. The guide pulley 31 is guided in the relatively deep, narrow part of the annular groove 25 of the hub 12 by means of a sliding or friction bushing 30 with a U-shaped cross section. At the same time the guide pulley 31 forms with the hub 12 two annular spaces 26, 27 for the two wire springs 15, 16. Whereas an inner rotation stop 38 and a guide loop 39 for the wire spring 15 can be seen on the first bowl-shaped part 21 of the hub 12, which are in each case formed out of the sheet metal, a corresponding inner rotation stop and a corresponding guide loop for the wire spring 16 are likewise provided on the other annular bowl-shaped part 22 of the hub 12 but cannot be seen here. These parts are in each case stamped out of the sheet metal.

After assembly, both wire springs 15, 16 should be pretensioned with respect to each other, that is, should in each case be spread radially compared to their untensioned starting position. With each relative twisting between the hub 12 and the pulley rim 14, one of the springs is additionally tensioned, whereas the second spring is detensioned without being entirely relieved of load, that is, the bearing against the respective rotation stop under pretensioning force should be maintained. The damping takes place on the one hand by means of the internal material damping of the wire springs 15, 16 and on the other hand by means of the relative surface friction between the guide pulley 31 of the pulley rim 14 and the annular groove 25 in the hub 12, which friction can be set by means of the properties and the lining of the sliding or friction bushing 30.

An outer rotation stop 38 and a guide loop 39 for the wire spring 16 are shown on the pulley rim 14. The pulley rim 14 is a moulded sheet metal part, with the belt pulley 32 on the pulley rim 14 being fabricated from a radially split outer edge of a blank. Two end regions with uniform curvature of different radii and a connecting spiral region can be seen on the wire spring 16. The end region with the larger radius bears against the cylindrical bearing region 44 of the belt rim 32, whereas the spiral region with the initially cylindrical and then spirally narrowing supporting region 45 of the belt rim 32 encloses a distance which first increases and then decreases and finally remains constant over the circumference. This distance is reduced progressively to zero when the hub 12—and thus the inner end 17 of the spring—is twisted with respect to the pulley rim 14 to the right as a result of an anti-clockwise widening of the spring 16. In this case the non-bearing deformable free spring length is shortened and the characteristic of the drive pulley becomes increasingly stiff.

Furthermore, an annular absorber mass 41 is arranged on the largest cylinder section of the annular bowl-shaped part 22, which absorber mass is configured so as to be able to vibrate rotationally with respect to the hub 12 by means of a vulcanized-on damper rubber 40 in order to absorb high-frequency vibrations. Vibrations of a shaft journal from the pulley rim 14 are to be effectively insulated thereby.

The rotational axis of the drive pulley is designated A. The rotational axis can include both the axis of rotation of the drive pulley as a whole as well as the axis of relative rotation between the hub 12 and the pulley rim 14.

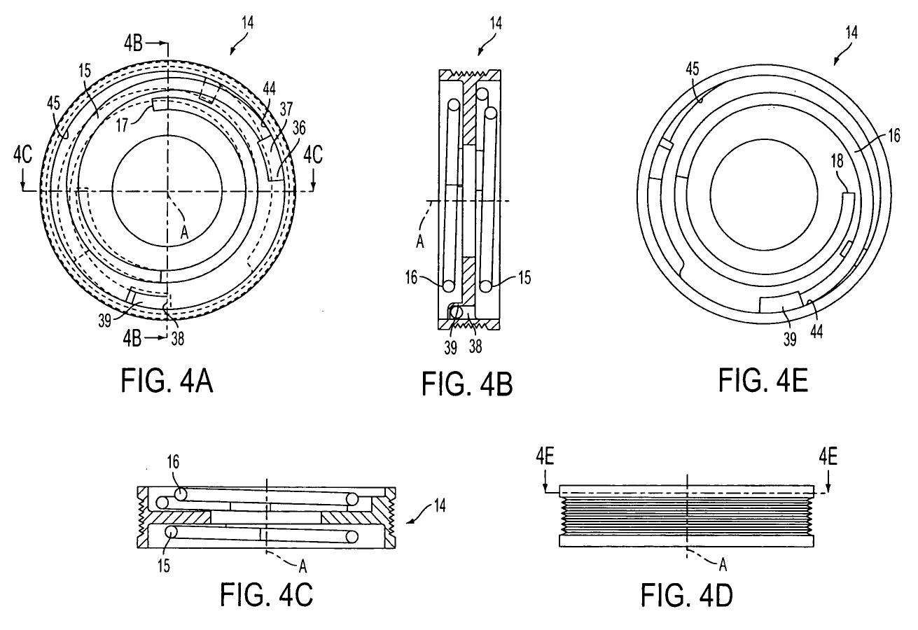

FIG. 4 shows the drive pulley 14 according to FIG. 3 as an assembly with the wire springs 15, 16, with the same details being referred to with the same reference symbols. The wire spring 15, the pulley rim 14 and the wire spring 16 can be seen in detail. An outer rotation stop 36 and a guide loop 37 for the wire spring 15, as well as an outer rotation stop 38 and a guide loop 39 for the wire spring 16 are shown on the pulley rim 14. The pulley rim 14 is a moulded sheet metal part, with the belt pulley 32 on the pulley rim 14 being fabricated from a radially split outer edge of a blank.

The wire spring 15 which is seen in illustration a) is guided radially outwards with a first end region into the guide loop 37 and supported in the circumferential direction against the rotation stop 36, and bears there against the cylindrical bearing region 44 of the pulley rim 14 which is followed by a likewise cylindrical supporting region 45. There is adjoined to the first end region a spiral-shaped region of the wire spring 15 which extends approximately 225°. The spiral region with the cylindrical supporting region 45 of the belt rim 32 encloses a distance which increases over the circumference. Adjoined to this spiral region is an inner, second end section with uniform curvature, that is with a constant radius, which extends approximately 180°. The distance formed between the wire spring 15 and the supporting region 45 is reduced progressively to zero when the hub 12 and thus the inner end 17 of the spring is twisted with respect to the pulley rim 14 to the right as a result of an anti-clockwise widening of the spring 15. In this case the non-bearing deformable free spring length is shortened and the characteristic of the drive pulley becomes increasingly stiff.

For the oppositely wound wire spring 16 which is seen in illustration e), the same applies correspondingly for a twisting of the hub and thus the inner end 18 of the spring against the pulley rim 14 to the right, which then leads to the wire spring 16 widening. As can be seen, the supporting face 45 comprises an inner cylinder section face and a narrowing spiral face which adjoins it in the circumferential direction, which spiral face can also be referred to as a ramp. In this case the radial distance at the unloaded drive pulley starting from the supporting region 44 can be provided initially to increase continuously in the circumferential direction between the wire spring 16 and the supporting face 45 and then provided to be approximately constant and/or decrease slightly in the region of the spiral face. When the two parts, hub 12 and pulley rim 14, are twisted with respect to each other, the bearing region 44 is extended in the region of the supporting face 45 while the free effective spring length is shortened progressively over the circumference.

The supporting face for the wire spring 15 can also have an inner cylinder section face and a narrowing spiral face which adjoins it in the circumferential direction, which is the case for the wire spring 16.

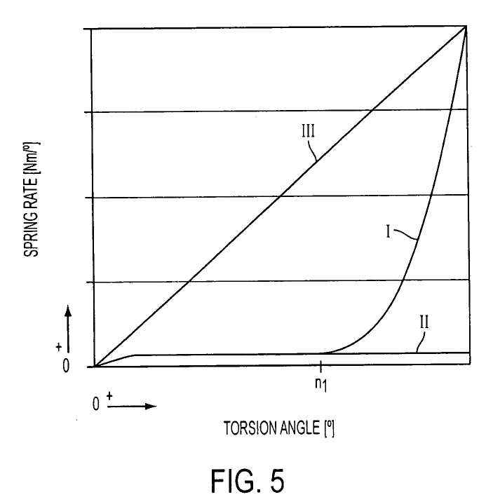

FIG. 5 shows the characteristic I of one of the wire springs according to the invention which initially runs largely linearly, and then from an angle of rotation of n₁ runs highly progressively, which is in comparison to a purely linear characteristic II according to the prior art, and which is in comparison to a purely progressive characteristic III according to the prior art. The angle of rotation is usually given in (degrees), and the spring stiffness is given in Nm/° (torque per degree).

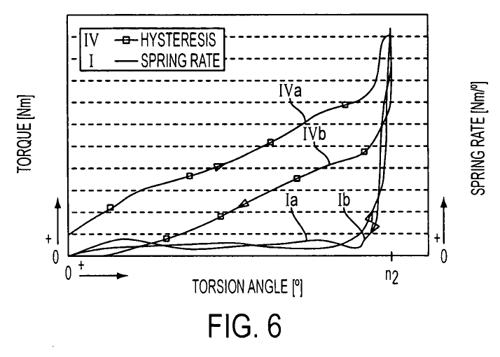

FIG. 6 shows the profile of the torque of the drive pulley according to the invention against the angle of rotation with the rising branch IVa and the falling branch IVb as well as the spring characteristic of one of the wire springs according to the invention, shown in principle above, which is here referred to with the term gradient, with the rising branch Ia and the falling branch Ib. In each case, the steeply rising part of the characteristic, close to n₂, the drive pulley can stiffen substantially without a noticeable jolt occurring. The torque is usually given in Nm, the angle of rotation also is given here in ° (degrees), and the gradient or spring stiffness is given in Nm/° (torque per degree).

The angle of rotation is one of relative rotation of the hub against the pulley rim, starting from the equilibrium position of the wire springs.

1. A drive pulley comprising a hub and a pulley rim, which are mounted in one another so as to be rotatable about a rotational axis, with at least two wound wire springs which are arranged in each case between the hub and the pulley rim in such a manner that they are wound around the rotational axis, with in each case one end being supported in the direction of rotation with respect to the hub and the other end being supported in the direction of rotation with respect to the pulley rim, and which form non-supported free spring length between the ends and which are installed in such a manner that they are pretensioned with respect to each other, wherein at least one of the wire springs bears at one end against a bearing region of one of the parts—hub and pulley rim—and then has a radial distance with respect to a curved supporting face on this one of the parts—hub and pulley rim respectively—which distance increases over the circumference and is reduced progressively to zero over the circumference when the parts—hub and pulley rim—are twisted with respect to each other, while the bearing region is extended into the region of the supporting face and the free spring length is shortened.

2. A drive pulley according to claim 1, wherein
the radial distance of the at least one of the wire springs form the supporting face on the unloaded drive pulley increases continuously in the circumferential direction starting from the bearing region.

3. A drive pulley according to claim 1, wherein
the radial distance of the at least one of the wire springs form the supporting face on the unloaded drive pulley increases first and is then constant and decreases in the circumferential direction starting from the bearing region.

4. A drive pulley according to claim 1, wherein
the curved supporting face is an inner cylinder face of the pulley rim.

5. A drive pulley according to claim 1, wherein
the curved supporting face is an outer cylinder face of the hub.

6. A drive pulley according to claim 1, wherein
the curved supporting face is an inner cylinder section face in the pulley rim with an adjoining, narrowing spiral face.

7. A drive pulley according to claim 1, wherein
the curved supporting face is an outer cylinder section face on the hub with an adjoining, widening spiral face.

8. A drive pulley according to claim 4, wherein
the at least two wound wire springs are radially widened compared to their untensioned shape when in their installation state in which they are pretensioned with respect to each other.

9. A drive pulley according to claim 5, wherein
the at least two wound wire springs are radially constricted compared to their untensioned shape when in their installation state in which they are pretensioned with respect to each other.

10. A drive pulley according to claim 1, wherein
the at least two wound wire springs have spring characteristics which differ from each other.

11. A drive pulley according to claim 1, wherein
the groups of the at least two wound wire springs have quantities which differ from each other.

12. A drive pulley according to claim 1, wherein
the at least one of the wire springs comprises in each case end regions with different, in each case constant radii and a spiral-shaped intermediate region.

13. A drive pulley according to claim 1, wherein
the at least one of the wire springs is wound spirally in one plane.

14. A drive pulley according to claim 1, wherein
the hub is comprised of two deep-drawn sheet metal parts.

15. A drive pulley according to claim 1, wherein
the hub is comprised of a first bowl-shaped part and a second annular bowl-shaped part, wherein two cylindrical regions are placed inside each other in a press fit and wherein the hub forms an annular groove in which the wire springs sit and the pulley rim is guided.

16. A drive pulley according to claim 1, wherein
the pulley rim comprises a guide pulley, which engages in the annular groove of the hub, and a belt rim which forms two annular spaces with the hub, which spaces are separated from the guide pulley.

17. A drive pulley according to claim 1, wherein
the radial distance of the at least one of the wire springs form the supporting face on the unloaded drive pulley increases first and is then constant or decreases in the circumferential direction starting from the bearing region.
